(19) United States
(12) Patent Application Publication
(10) Pub. No.: US 2026/0079759 A1
(43) Pub. Date: Mar. 19, 2026

(54) I/O UNLOADING METHOD AND SYSTEM IN CLOUD ENVIRONMENT, DEVICE, AND STORAGE MEDIUM

(71) Applicant: CLOUD INTELLIGENCE ASSETS HOLDING (SINGAPORE) PRIVATE LIMITED, Singapore (SG)

(72) Inventor: Xiaodong GONG, Hangzhou, Zhejiang (CN)

(21) Appl. No.: 19/106,992

(22) PCT Filed: Aug. 23, 2023
(86) PCT No.: PCT/CN2023/114511

§ 371 Date: Feb. 26, 2025

(30) Foreign Application Priority Data
Aug. 30, 2022 (CN) 202211060455.3

(51) Int. Cl. G06F 9/50

(52) U.S. Cl. CPC G06F 9/5038; G06F 9/505; G06F 9/5077

(57) ABSTRACT

Embodiments of the present application provide an I/O unloading method and system in a cloud environment, a device, and a storage medium. In the present application, a CPU of a host machine is additionally equipped with a queue component, and it is innovatively proposed to use the queue component in an I/O processing process. Based on this, a virtual I/O device and a device queue corresponding to the virtual I/O device can be provided for an instance on the host machine through the queue component; in the CPU, scheduling is performed on an I/O request occurring between the instance and the virtual I/O device by using the device queue; and an original I/O unloading card only needs to be responsible for listening to the I/O request in the device queue and transferring data related to the I/O request which effectively improves the I/O processing efficiency.

### CROSS-REFERENCE TO RELATED APPLICATIONS

This application is a National Stage of International Application No. PCT/CN2023/114511, filed on Aug. 23, 2023, which claims priority to Chinese Patent Application No. 202211060455.3, filed to the China National Intellectual Property Administration on Aug. 30, 2022 and entitled “I/O UNLOADING METHOD AND SYSTEM IN CLOUD ENVIRONMENT, DEVICE, AND STORAGE MEDIUM”. The two applications are hereby incorporated by reference in their entireties.

### TECHNICAL FIELD

The present application relates to the field of cloud computing technology, and in particular, to an input/output (I/O) unloading method and system in a cloud environment, a device, and a storage medium.

### BACKGROUND

As marginal cost of central processing unit (CPU) performance growth increases sharply, an I/O unloading card came into being. The I/O unloading card, also known as a distributed processing unit (DPU) and an instruction processing unit (IPU), can provide an I/O computation engine for high-bandwidth, low-latency and data-intensive computing scenarios.

At present, I/O processing work is completely unloaded to the I/O unloading card, and I/O processing work on the I/O unloading card is separated from a CPU data link of a host machine. This separation structure leads to problems such as data overflow often occurring in the current I/O processing, and the processing efficiency is poor.

### SUMMARY

Various aspects of the present application provide an I/O unloading method and system in a cloud environment, a device, and a storage medium, which are used for improving the I/O processing efficiency in the cloud environment.

An embodiment of the present application provides an I/O unloading system in a cloud environment, including: a CPU of a host machine and an I/O unloading card plugged into the host machine, the CPU is equipped with a queue component,
the queue component is configured to: provide a virtual I/O device and a device queue corresponding to the virtual I/O device for an instance on the host machine; and in the CPU, perform scheduling on an I/O request occurring between the instance and the virtual I/O device by using the device queue;
the I/O unloading card is configured to: listen to the I/O request in the device queue; and transfer data related to the listened I/O request between the instance and a physical I/O device corresponding to the virtual I/O device.

An embodiment of the present application provides an I/O unloading method in a cloud environment, applicable for a CPU in a host machine, where the CPU is equipped with a queue component, and the method includes:
providing a virtual I/O device for an instance on the host machine by using the queue component;
configuring a corresponding device queue for the virtual I/O device by using the queue component; and
in the CPU, performing scheduling on an I/O request occurring between the instance and the virtual I/O device by using the device queue, to allow an I/O unloading card plugged in the host machine to listen to the I/O request in the device queue and transfer data related to the listened I/O request between the instance and a physical I/O device corresponding to the virtual I/O device.

An embodiment of the present application further provides an I/O unloading method in a cloud environment, applicable for an I/O unloading card plugged into a host machine, where a CPU of the host machine is equipped with a queue component, and the method includes:
listening to an I/O request occurring between an instance on the host machine and a virtual I/O device provided by the queue component for the instance from a device queue in the queue component;
obtaining data related to the listened I/O request; and
transferring the data related to the listened I/O request between the instance and a physical I/O device corresponding to the virtual I/O device.

An embodiment of the present application further provides a CPU, installed in a host machine, where the CPU is equipped with a queue component, and the CPU is configured to execute one or more computer instructions to:
provide a virtual I/O device for an instance on the host machine by using the queue component;
configure a corresponding device queue for the virtual I/O device by using the queue component; and
in the CPU, perform scheduling on an I/O request occurring between the instance and the virtual I/O device by using the device queue, to allow an I/O unloading card plugged in the host machine to listen to the I/O request in the device queue and transfer data related to the listened I/O request between the instance and a physical I/O device corresponding to the virtual I/O device.

An embodiment of the present application further provides an I/O unloading card, plugged into a host machine, where a CPU of the host machine is equipped with a queue component, and the I/O unloading card includes a memory and a processor,
the memory is configured to store one or more computer instructions;
the processor is coupled to the memory and configured to execute the one or more computer instructions to:
listen to an I/O request occurring between an instance on the host machine and a virtual I/O device provided by the queue component for the instance from a device queue in the queue component;
obtain data related to the listened I/O request; and
transfer the data related to the listened I/O request between the instance and a physical I/O device corresponding to the virtual I/O device.

An embodiment of the present application further provides a computer-readable storage medium storing computer instructions, where the computer instructions, when executed by one or more processors, cause the one or more processors to perform the I/O unloading method in the cloud environment mentioned above.

In the present application, a CPU of a host machine is additionally equipped with a queue component, and it is innovatively proposed to use the queue component in an I/O processing process. Based on this, a virtual I/O device and a device queue corresponding to the virtual I/O device can be provided for an instance on the host machine through the queue component; in the CPU, scheduling is performed on an I/O request occurring between the instance and the virtual I/O device by using the device queue; and an original I/O unloading card only needs to be responsible for listening to the I/O request in the device queue and transferring data related to the I/O request. In this way, the device queue in the I/O processing process can be moved up to the CPU, so that it can be linked with each component in the CPU in the process of the I/O scheduling to obtain a real-time load of each core in the CPU, which can realize I/O scheduling more reasonably without blind scheduling, thereby effectively improving the I/O processing efficiency.

### BRIEF DESCRIPTION OF DRAWINGS

The accompanying drawings illustrated herein are used to provide a further understanding of the present application and constitute a part of the present application. The illustrative embodiments of the present application and their descriptions are used to explain the present application and do not constitute undue limitations on the present application. The accompanying drawings are as follows.

FIG. 1 is a schematic structural diagram of an I/O unloading system in a cloud environment provided by an exemplary embodiment of the present application.

FIG. 2 is a schematic structural diagram corresponding to an implementation solution of an I/O unloading system provided by an exemplary embodiment of the present application.

FIG. 3 is a schematic structural diagram of an implementation solution of an I/O unloading system provided by an exemplary embodiment of the present application.

FIG. 4 is a logical schematic diagram of an instance creation process provided by an exemplary embodiment of the present application.

FIG. 5 is a logical schematic diagram of an instance destruction process provided by an exemplary embodiment of the present application.

FIG. 6 is a schematic flowchart of an I/O unloading method in a cloud environment provided by another exemplary embodiment of the present application.

FIG. 7 is a schematic flowchart of another I/O unloading method in a cloud environment provided by another exemplary embodiment of the present application.

FIG. 8 is a schematic structural diagram of a CPU provided by yet another exemplary embodiment of the present application.

FIG. 9 is a schematic structural diagram of an I/O unloading card provided by yet another exemplary embodiment of the present application.

### DESCRIPTION OF EMBODIMENTS

In order to make objectives, technical solutions, and advantages of the present application more clear, the following will be combined with the specific embodiments of the present application and the corresponding drawings to describe the technical solution of the present application clearly and completely. Obviously, the embodiments described are only a part of the embodiments of the present application and not all embodiments. Based on the embodiments in the present application, all other embodiments obtained by a person skilled in the art without making creative efforts are within the scope of protection in the present application.

At present, I/O processing work is completely unloaded into the I/O unloading card, which is inefficient for the I/O processing. To this end, in some embodiments of the present application, a CPU of a host machine is additionally equipped with a queue component, and it is innovatively proposed to use the queue component in an I/O unloading processing process. Based on this, a virtual I/O device and a device queue corresponding to the virtual I/O device can be provided for an instance on the host machine through the queue component; in the CPU, scheduling is performed on an I/O request occurring between the instance and the virtual I/O device by using the device queue; and an original I/O unloading card only needs to be responsible for listening to the I/O request in the device queue and transferring data related to the I/O request. In this way, the device queue in the I/O unloading processing process can be moved up to the CPU, so that it can be linked with each component in the CPU in the process of the I/O scheduling to obtain a real-time load of each core in the CPU, which can realize I/O scheduling more reasonably without blind scheduling, thereby effectively improving the I/O processing efficiency.

The technical solutions provided by the embodiments of the present application are described in detail below with reference to the accompanying drawings.

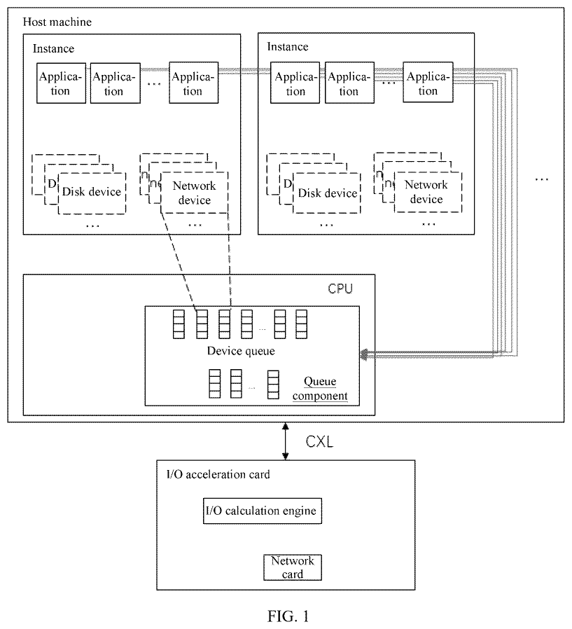

FIG. 1 is a schematic structural diagram of an I/O unloading system in a cloud environment provided by an exemplary embodiment of the present application. As shown in FIG. 1, the system includes: a CPU of a host machine and an I/O unloading card plugged into the host machine.

The I/O unloading card can be implemented by adopting a chip such as a DPU and an IPU, and of course, this embodiment is not limited to this. The host machine can be a physical machine in a cloud environment, and referring to FIG. 1, in the cloud environment, multiple instances can be run on a single host machine. A core technology under a cloud nativity is a virtualization technology, and based on the virtualization technology, several virtual CPUs (VCPUs) can be virtualized on the CPU of the host machine, and the instances can run depending on the VCPUs.

This embodiment proposes to additionally add a queue component to the CPU of the host machine. In this embodiment, the queue component can be implemented by adopting a manner of hardware or software. In an implementation, in this embodiment, a hardware such as an application specific integrated circuit ASIC can be adopted to construct the queue component, and of course, this embodiment is not limited to this. In addition, the queue component additionally equipped to the CPU in this embodiment can not only be configured to provide queue function for I/O processing work in this embodiment, but also be reused in other scenarios to provide the queue function for other scenarios.

In this embodiment, the queue component can access an internal bus of the CPU. In this embodiment, a form of the queue component accessing the internal bus of the CPU is not limited, and the access manner can be selected according to the actual situation. For example, the queue component can be connected to a PCIe controller in the CPU to access the internal bus of the CPU. For another example, the queue component can be connected to other components of the CPU through a UCIe bus. In addition, the queue component can also be connected to a memory controller or an acceleration module in the CPU to interact with the memory or acceleration module of the CPU. On the other side, the queue component can also be interconnected with the I/O unloading card plugged into the host machine. In an implementation, the queue component can be interconnected with the I/O unloading card through a cache coherence bus protocol such as a CXL. In this way, referring to FIG. 1, the queue component additionally equipped to the CPU can support a linkage between the I/O unloading card and the CPU of the host machine, and change a current situation that the I/O unloading card is separated from the CPU data link in the traditional I/O processing solution.

Referring to FIG. 1, the queue component in this embodiment can be configured to provide a virtual I/O device and a device queue corresponding to the virtual I/O device for an instance on the host machine. In this embodiment, the queue component can perform I/O virtualization on a physical I/O device that needs to perform I/O with the instance to generate a virtual I/O device (for example, a disk device and a network device in the figure) corresponding to the physical I/O device. The disk device obtained through the virtualization can include, but is not limited to, a blk device, etc., and the network device obtained through the virtualization can include, but is not limited to, a net device, etc. The queue component can provide the virtual I/O device for the instance on the host machine by adopting multiple I/O virtualization solutions, and the specific solutions will be described in detail later. It should be understood that the virtual I/O device here is a definition of level of the operating system OS, that is, the virtual I/O device is visible for an OS of the host machine, and the virtual I/O device represents each entity device involved in the I/O process. In addition, in this embodiment, an implementation form of the device queue is not limited, and an implementation form such as a first-in first-out FIFO queue can be adopted. In this embodiment, the I/O request can be managed by using the device queue. For ease of description, in this embodiment, I/O unloading process will be described from a perspective of a single instance, but it should be understood that multiple instances can be hosted on the host machine, and the I/O unloading solution for each instance is consistent.

It should be noted that, referring to FIG. 1, in this embodiment, the queue component can provide several virtual I/O devices for a single instance. For ease of description, the I/O unloading solution will be described later from a perspective of a single virtual I/O device, but it should be understood that the same optimization solution can be adopted to optimize the I/O processing process involved in other virtual I/O devices provided for a single instance.

On this basis, an I/O request can occur between the instance on the host machine and the virtual I/O device provided by the queue component for the instance. Preferably, the I/O request occurring between the instance and the virtual I/O device adopts an IO-uring protocol, and by adopting a general protocol such as IO-uring, a problem that different device queues implemented by different CPU platforms that need to be adapted when the I/O unloading card is linked with the different CPU platforms can be avoided, that is, the adaptation problem does not need to be considered. Certainly, this is only preferred, the I/O request occurring between the instance and the virtual I/O device in this embodiment can also adopt a protocol, as long as it is guaranteed that the two parties reach an agreement in advance. The queue component can perform scheduling on the I/O request occurring between the instance and the virtual I/O device using the device queue in the CPU. The scheduling algorithm can be a five-tuple hash, a secret key hash, etc., which is not limited in this embodiment. In this way, the device queue involved in the I/O processing process is moved up to the CPU, and the queue component can be linked with each component inside the CPU, which makes the scheduling working of the I/O request performed by the queue component based on the device queue no longer blind, but can take the real-time load of each core in the CPU as the scheduling basis, so that the scheduling of the I/O request, especially a read request sent by the instance to the virtual I/O device, can be completed more reasonably, which avoids a problem of data overflow caused by unreasonable scheduling in a process of the read request.

As mentioned above, the queue component is also interconnected with the I/O unloading card plugged into the host machine. In this way, the I/O unloading card no longer needs to undertake the scheduling work of the I/O request, and this part of work is moved up to the CPU and is undertook by the queue component. Other work of the I/O unloading card can be reserved, and the I/O unloading card can docked into the device queue provided by the queue component for the virtual I/O device, and listen to the I/O request in the device queue. Accordingly, the I/O unloading card can listen to the I/O request occurring between the instance and the virtual I/O device.

In this way, based on the queue component configured for CPU, the device queue is respectively docked with the virtual I/O device and the I/O unloading card. In this embodiment, the data link is that the virtual I/O device transfers the I/O request occurring between the virtual I/O device and the instance to the device queue, and the device queue transfers the I/O request to the I/O unloading card, allowing the I/O unloading card to sense the I/O request.

Referring to FIG. 1, the I/O unloading card can also be configured to transfer data related to the listened I/O request between the instance and the physical I/O device corresponding to the virtual I/O device. The I/O unloading card can be used as a middleware between the physical I/O device and the instance on the host machine, providing data interaction support therebetween.

In addition, in this embodiment, an acceleration module can also be provided in the queue component, and the acceleration module can be configured to perform acceleration processing on data related to the I/O request occurring between the instance and the virtual I/O device. The acceleration processing in this embodiment can include, but is not limited to, encryption and decryption, compression or statistical unloading. Similarly, the acceleration module can also be provided in the I/O unloading card, and the acceleration module therein can also be configured to perform acceleration processing on the data related to the I/O request occurring between the instance and the virtual I/O device. Based on the acceleration module provided in the queue component, the following can be realized.
1. A customer can configure a specified virtual I/O device to enable encryption and decryption, compression, statistical unloading and other functions, and the virtual function (VF) bound by the device queue corresponding to the virtual I/O device can be associated with a specified acceleration module. A memory address allocated by the customer for the virtual I/O device can also be associated with the specified acceleration module, so that when reading and writing the memory address, the acceleration processing is performed on the data through the specified acceleration module.
2. When an application in the instance initiates a write request to the virtual I/O device, the acceleration module can perform preprocessing on the data before it enters the memory space allocated by the customer.
3. An I/O calculation engine of the I/O unloading card receives data from a communication component, and the I/O calculation engine performs direct memory access (DMA) on the data to the memory space pre-allocated by the customer. The acceleration module can perform preprocessing on the data before it enters the memory space allocated by the customer.

In this way, based on the acceleration module provided in the queue component, the data link in this embodiment becomes: the virtual I/O device transfers the I/O request occurring between the virtual I/O device and the instance to the device queue; the device queue triggers the acceleration module to access the memory address and perform the acceleration processing on the data related to the I/O request; the device queue transfers the I/O request to the I/O unloading card, so that the I/O unloading card can sense the I/O request and read the data after the acceleration processing from the memory address. This can make acceleration range of the acceleration module cover a whole path of data. For example, the encryption and decryption module provided by the queue component can ensure an encrypted state of data in the whole path, and change the current situation where data acceleration can only be performed by I/O unloading card at the end of the data transmission path in the traditional solution.

In view of the foregoing, in this embodiment, a CPU of a host machine is additionally equipped with a queue component, and it is innovatively proposed to use the queue component in an I/O processing process. Based on this, a virtual I/O device and a device queue corresponding to the virtual I/O device can be provided for an instance on the host machine through the queue component; in the CPU, scheduling is performed on an I/O request occurring between the instance and the virtual I/O device by using the device queue; and an original I/O unloading card only needs to be responsible for listening to the I/O request in the device queue and transferring data related to the I/O request. In this way, the device queue in the I/O processing process can be moved up to the CPU, so that it can be linked with each component in the CPU in the process of the I/O scheduling to obtain a real-time load of each core in the CPU, which can realize I/O scheduling more reasonably without blind scheduling, thereby effectively improving the I/O processing efficiency.

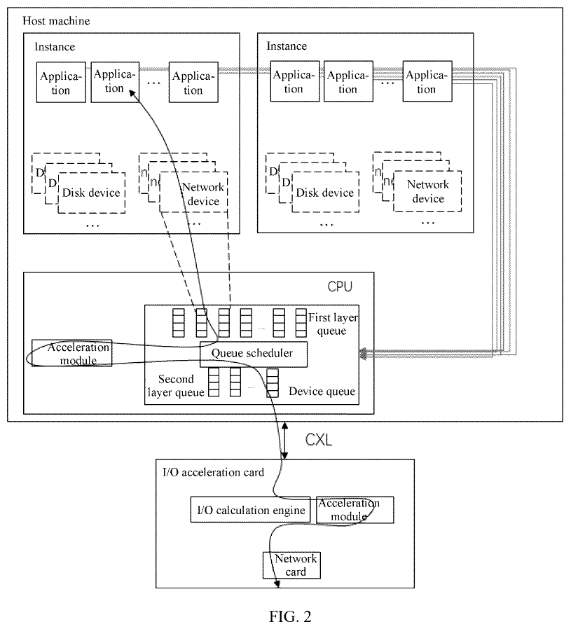

FIG. 2 is a schematic structural diagram corresponding to an implementation solution of an I/O unloading system provided by an exemplary embodiment of the present application. Referring to FIG. 2, in the above or below embodiments, the device queue provided by the queue component can include a first layer queue and a second layer queue. The first layer queue can be docked with the VCPU in the instance, and the second layer queue can be docked with the physical I/O device through the I/O unloading card. Referring to FIG. 2, for one of the virtual I/O devices provided for the instance, the queue component can associate a first layer queue of a first specified number and a second layer queue of a second specified number for the virtual I/O device; establish a mapping relationship between the first layer queue and the second layer queue associated with the virtual I/O device; dock the first layer queue associated with the virtual I/O device to each VCPU in the instance; and dock the second layer queue associated with the virtual I/O device to the physical I/O device corresponding to the virtual I/O device through the I/O unloading card.

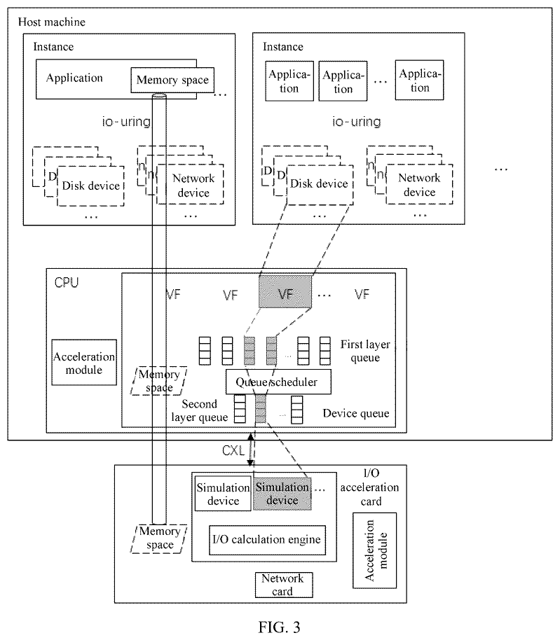

FIG. 3 is a schematic structural diagram of an implementation solution of an I/O unloading system provided by an exemplary embodiment of the present application, which shows an implementation solution of docking the first layer queue associated with the virtual I/O device to the VCPU in the instance and an implementation solution of docking the second layer queue associated with the virtual I/O device to the physical I/O device corresponding to the virtual I/O device.

Referring to FIG. 3, as mentioned above, the queue component can provide the virtual I/O device for the instance on the host machine by adopting multiple I/O virtualization solutions. In an exemplary implementation, an SRIOV (Single Root I/O Virtualization) technology can be adopted to create a VF device for the physical I/O device that needs to perform I/O with an instance, where the VF device is configured to perform exchange data with each VCPU in the instance; and the VF device is registered as a virtual I/O device of a specified type by using an operating system of the instance. For example, the operating system of the instance can register the VF as a disk, a network device, etc. according to PCIe <vender ID, device ID> of the VF. The physical I/O device in this embodiment can include, but is not limited to, high-performance I/O devices such as a cloud network card and a cloud disk (for example, a solid state drive (SSD)). In practical application, each SR-I/OV device can have a physical function (PF), and each PF can have at most 64000 virtual functions (VFs) associated therewith. The PF can create the VF through a register that is designed with attributes specific to this purpose. Once SR-I/OV is enabled in the PF, a PCI configuration space for each VF can be accessed through a bus, device, and function number, etc. of the PF. Each VF has a PCI memory space for mapping its register set. A driver program of the VF device performs operation on the register set to enable its functionality and is shown as a physically present PCI device. After the VF is created, the VF device can be directly assigned to each application in the instance, so that the VF device in the queue component can perform data exchange with each VCPU in the instance.

Based on this, referring to FIG. 3, the first layer queue associated with the virtual I/O device can be bound to the VF device corresponding to the virtual I/O device to perform exchange data with each VCPU in the instance.

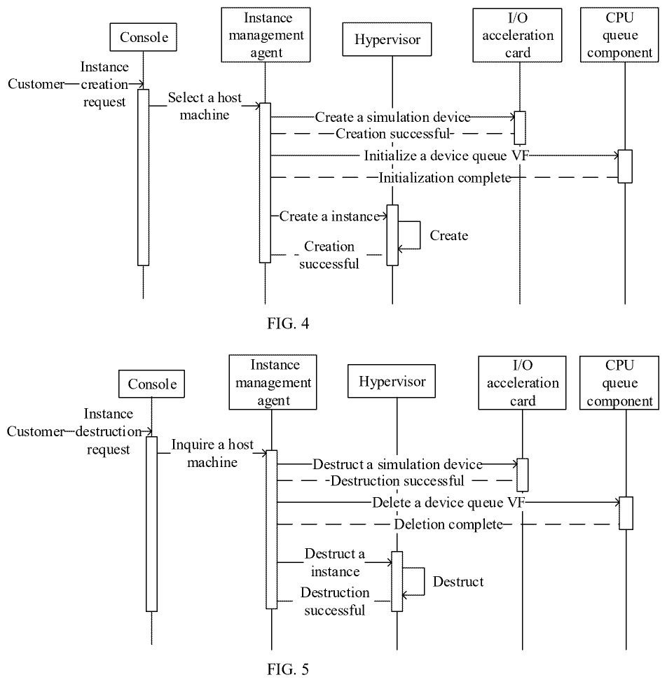

Continuing to refer to FIG. 3, for the I/O unloading card, the physical I/O device can be simulated to generate a simulation device corresponding to the physical I/O device. Based on this, the second layer queue associated with the virtual I/O device may be bound to the simulation device, so as to dock the second layer queue associated with the virtual I/O device to the physical I/O device corresponding to the virtual I/O device. The I/O unloading card can realize the simulation of the physical I/O device by adopting a manner of software simulation or hardware simulation, which is not limited in this embodiment. It should be understood that in the cloud environment, the deployment form of the physical I/O device may be distributed or clustered, the I/O unloading card is to simulate the simulation device on a corresponding distributed system or cluster to participate in the I/O processing process, and finally, the I/O unloading card can accurately transfer the I/O request to the physical I/O device through the simulation device. That is, the I/O computation engine in the I/O unloading card can provide the simulated device of a specified number, each of which is bound to the second layer queue of a specified number in the device queue in the CPU to read or transfer data. Certainly, in this embodiment, other implementation solutions can also be adopted to dock the second layer queue associated with the virtual I/O device to the physical I/O device corresponding to the virtual I/O device, and it is not limited to this simulating solution, which will not be exhaustive here. FIG. 4 is a logical schematic diagram of an instance creation process provided by an exemplary embodiment of the present application. FIG. 5 is a logical schematic diagram of an instance destruction process provided by an exemplary embodiment of the present application. The above queue docking solution will be described below by way of creation/destruction process of the instance.

Referring to FIG. 4, an exemplary instance creation process can be that:
1. the customer initiates an instance creation request through a console or openAPI;
2. the console can schedule the creation request to the most suitable host machine;
3. an instance management agent can be run on the host machine to create a simulation device corresponding to a physical I/O device such as a cloud network card or a cloud disk on an I/O computing engine of the I/O unloading card, and bind the simulation device to the second layer queues of a specified number in the device queue; and
4. the queue component in the CPU of the host machine can create multiple VFs required on the device queue, bind a specified first layer queue, and establish a mapping relationship with the second layer queue in step 3;
5. The instance management agent on the host machine can create the instance by calling Hypervisor.

Referring to FIG. 5, an exemplary instance destruction process can be that:
1. the customer initiates an instance destruction request through a console or openAPI;
2. the console can find a host machine where the instance is located, and issue a delete command through an instance management agent on the host machine;
3. the instance management agent can delete a relevant simulation device corresponding to a physical I/O device such as a cloud network card or a cloud disk on an I/O computing engine of the I/O unloading card, and the queue component in the CPU of the host machine can delete a related VF on the device queue; and
4. the instance management agent calls Hypervisor to delete the instance.

It can be seen from FIG. 4 and FIG. 5 that in this embodiment, in the creation/destruction process of an instance, the multiple virtual I/O devices and the multiple simulation devices required are created from the granularity of a single instance, and the docking process of two layer queues is performed. It is worth noting that, in the normal operation of the instance, if it occurred that there is an addition or reduction of physical I/O devices, a series of entity objects (VF device-first layer queue-second layer queue-simulation device) managed by the single virtual I/O device in FIG. 3 can be configured from the granularity of the single device, that is, every time a physical I/O device that needs to perform I/O with the instance is added, one virtual I/O device and the series of entity objects managed by the virtual I/O device in FIG. 3 can be added.

In addition, it is worth noting that, in this embodiment, the virtual I/O device is generated by virtualizing the physical I/O device, and is mainly configured to support the instance on the host machine to discover a physical I/O device. The simulation device in the I/O unloading card is generated by simulating the physical I/O device, which is mainly configured to simulate the hardware behavior of the physical I/O device. Based on the various implementation solutions provided in the full text, it can be seen that in this embodiment, the entity object participating in the I/O processing process can include: a VF device—a first layer queue—a second layer queue—a simulation device—a network card—a physical I/O device. The virtual I/O device mentioned above represents these entities participating in the I/O processing process. The simulation devices in the I/O unloading card represent the last mentioned physical I/O devices in these entities. In this embodiment, both the virtual I/O device and the simulation device functions are configured to support I/O virtualization under the cloud nativity. In this way, in this embodiment, the first layer queue associated with the virtual I/O device can be bound to the VF device to perform exchange data with each VCPU in the instance; the second layer queue associated with the virtual I/O device can be bound to the simulation device in the I/O unloading card and perform exchange data. The first layer queue associated with the virtual I/O device can be mapped to its associated second layer queue in an N:1 ratio, that is, the number of the first layer queue associated with the virtual I/O device is usually greater than the number of its associated second layer queue. Based on the two-layer queue structure, the write request initiated by the instance to the virtual I/O device can be scheduled to a suitable physical I/O device by mapping from the first layer queue to the second layer queue; the read request initiated by the instance to the virtual I/O device can be scheduled to a suitable VCPU by mapping from the second layer queue to the first layer queue.

The process of performing scheduling based on the two-layer queue structure will be described in detail below.

Referring to FIG. 2, the queue component can read load information of each VCPU in the instance in a process of the instance initiating a read request to the virtual I/O device; and schedule the read request to a first queue in the first layer queue associated with the virtual I/O device according to the load information, to process the read request by using a VCPU docked with the first queue. In an implementation, the first queue may be a queue docked with a VCPU with the lowest load. In this way, the read request can be scheduled to the VCPU with the optimal load for processing, so that the I/O processing efficiency can be improved. In this process, the I/O unloading card can obtain a response message corresponding to the read request; and add metadata information in the response message to a specified queue in the second layer queue associated with the virtual I/O device. The queue component can schedule the metadata information in the specified queue to the first queue according to the load information. In addition, the host machine can allocate memory space for the instance, and the I/O unloading card can transfer the data related to the listened I/O request between the instance and the physical I/O device corresponding to the virtual I/O device based on the memory space. In an exemplary solution, the I/O unloading card can write a data portion in the response message into a memory space corresponding to the instance; and add a memory address where the data portion is located to the metadata information; and based on this, the queue component can trigger a VCPU docked with a target queue to read the data portion in the response message according to the memory address in the metadata information. Thus, the read request initiated by the instance to the virtual I/O device is completed.

In this embodiment, when the instance reads from or writes to the virtual I/O device, the system call can allocate a memory space such as sk_buf similar to the network. The device queue references the memory space through address access, and the I/O unloading card can access the memory space through DMA or a mode similar to Intel secure virtual machine (SVM).

For example, a practical application solution can be that:
1. an application in the instance can open the virtual I/O device (such as the disk device and the network device in FIG. 2) based on the io-uring protocol, submit a read request using io_uring_smp_store_release, and trigger a receiver to obtain data from the device queue using io_uring_enter;
2. an I/O computing engine of the I/O unloading card receives a response message from a communication component (such as the network card in FIG. 2), and determines a simulation device to which the message belongs based on a metadata portion of the message. The data portion of the message is written into the DMA memory space of the simulation device. In the process of data writing, the acceleration module of I/O unloading card can be used for data preprocessing;
3. the I/O computing engine generates metadata information of the read request in Io-uring format, which contains the DMA memory address where the data portion is written. The I/O computing engine can write the metadata information of the read request into the second layer queue of the device queue in the CPU;
4. a queue scheduler running in the queue component can read power consumption, time slice utilization rate, power manage unit (PMU), etc. of each VCPU of the instance, and make real-time statistics on the real-time load of each VCPU. Combined with the set scheduling strategies such as the five-tuple hash, secret key hash, the read request in the second layer queue is scheduled to the target queue in the first layer queue;
5. an operating system of the instance can wake up the application that submitted the read request, read the metadata information of the read request from the target queue of the device queue, read the memory address where the data portion is located from the metadata information, and read the data from the memory address.

Referring to FIG. 2, the queue component can add metadata information of a write request initiated by the instance to the virtual I/O device into the first layer queue associated with the virtual I/O device; and schedule the metadata information of the write request to a second queue in the second layer queue associated with the virtual I/O device; and the I/O unloading card can process the write request by using a physical I/O device docked with the second queue. In this process, the queue component can write a data portion corresponding to the write request into a memory space corresponding to the instance; and add a memory address where the data portion is located to the metadata information. The I/O unloading card can read the metadata information from the second queue; obtain the data portion of the write request according to the memory address in the metadata information; and send the data portion to the physical I/O device docked with the second queue.

For example, a practical application solution can be that:
1. an application in the instance can open the virtual I/O device (such as the disk device and the network device in FIG. 2) based on the io-uring protocol, submit a write request using io_uring_smp_store_release, and trigger a receiver to obtain data from the device queue using io_uring_enter;
2. a data portion of the write request is in a memory space allocated for the application, and metadata information of the write request enters the first layer queue of the device queue;
3. a queue scheduler running in the queue component can send the write request in the first layer queue to a specified second layer queue according to information such as a mapping relationship between the first layer queue and the second layer queue, a weight of the first layer queue, and a number of idle queue entries in the second layer queue.
4. use the acceleration module in the CPU for data preprocessing, such as data encryption and data compression, etc. ;
5. the I/O computing engine of the I/O unloading card reads the metadata information of the write request in the second layer queue of the queue component in the CPU, so as to obtain information such as access and memory addresses of the data portion.
6. the I/O computing engine adds a metadata message header such as a virtual network card and a cloud disk, and sends the data submitted by the application to the target host machine or back-end storage cluster through the communication component of the I/O unloading card. In the process of data transmission, the acceleration module of I/O unloading card can be used for data preprocessing.

Accordingly, the reasonable scheduling of the I/O request occurring between the instance and the virtual I/O device can be realized through the queue component. The device queue is moved up to the CPU, which can support the use of tools to configure the scheduling strategy of the device queue in the CPU in-band on the instance, and it no longer needs to be configured by the console as in the traditional solution. The solution for configuring the scheduling strategy in the device queue provided by this embodiment can improve configuration of requests-per-second (QPS) by several orders of magnitude, thereby solving a problem that the traditional solution is not high in real-time performance and cannot meet requirements of rapid creation and destruction of container and serverless scenes. In addition, in the process of transferring the data related to the I/O request by the I/O unloading card, a encryption and decryption module in the CPU can be configured to encrypt the data before entering the I/O unloading card. In this way, the I/O unloading card will no longer be able to see a data plaintext, so that the security of the user data is greatly improved.

FIG. 6 is a schematic flowchart of an I/O unloading method in a cloud environment provided by another exemplary embodiment of the present application. The method can be implemented by a CPU in a host machine in the system embodiment mentioned above, and the CPU is equipped with a queue component. Referring to FIG. 6, the method can include:
step 600, provide a virtual I/O device for an instance on the host machine by using the queue component;
step 601, configure a corresponding device queue for the virtual I/O device by using the queue component; and
step 602, in the CPU, perform scheduling on an I/O request occurring between the instance and the virtual I/O device by using the device queue, to allow an I/O unloading card plugged in the host machine to listen to the I/O request in the device queue and transfer data related to the listened I/O request between the instance and a physical I/O device corresponding to the virtual I/O device.

In an embodiment, an application specific integrated circuit ASIC is adopted to construct the queue component, the queue component is connected to an internal bus of the CPU.

In an embodiment, the device queue is respectively docked with the virtual I/O device and the I/O unloading card, and the virtual I/O device transfers the I/O request occurring between the virtual I/O device and the instance to the device queue, and the device queue transfers the I/O request to the I/O unloading card, allowing the I/O unloading card to sense the I/O request.

In an embodiment, the device queue includes a first layer queue and a second layer queue, and the method further includes:
associating a first layer queue of a first specified number and a second layer queue of a second specified number for the virtual I/O device;
establishing a mapping relationship between the first layer queue and the second layer queue associated with the virtual I/O device;
docking the first layer queue associated with the virtual I/O device to each VCPU in the instance; and
docking the second layer queue associated with the virtual I/O device to the physical I/O device corresponding to the virtual I/O device through the I/O unloading card.

In an embodiment, the step of performing scheduling on the I/O request occurring between the instance and the virtual I/O device includes:
reading load information of each VCPU in the instance in a process of the instance initiating a read request to the virtual I/O device; and
scheduling the read request to a first queue in the first layer queue associated with the virtual I/O device according to the load information, to process the read request by using a VCPU docked with the first queue.

In an embodiment, the step of scheduling the read request to the first queue in the first layer queue associated with the virtual I/O device according to the load information includes:
scheduling metadata information in a specified queue to the first queue according to the load information, where the I/O unloading card obtains a response message corresponding to the read request, and adds the metadata information in the response message to the specified queue in the second layer queue associated with the virtual I/O device.

In an embodiment, the method further includes:
triggering a VCPU docked with a target queue to read a data portion in the response message according to a memory address in the metadata information, where the I/O unloading card writes the data portion in the response message into a memory space corresponding to the instance; and adds the memory address where the data portion is located to the metadata information.

In an embodiment, the step of performing scheduling on the I/O request occurring between the instance and the virtual I/O device by using the device queue includes:
adding metadata information of a write request initiated by the instance to the virtual I/O device into the first layer queue associated with the virtual I/O device; and
scheduling the metadata information of the write request to a second queue in the second layer queue associated with the virtual I/O device;
where the I/O unloading card processes the write request by using a physical I/O device docked with the second queue.

In an embodiment, the method further includes:
writing a data portion corresponding to the write request into a memory space corresponding to the instance; and adding a memory address where the data portion is located to the metadata information;
where the I/O unloading card reads the metadata information from the second queue; obtains the data portion of the write request according to the memory address in the metadata information; and sends the data portion to the physical I/O device docked with the second queue.

In an embodiment, the step of providing the virtual I/O device for the instance on the host machine includes:
performing I/O virtualization on a physical I/O device that needs to perform I/O with the instance to generate a virtual I/O device corresponding to the physical I/O device.

In an embodiment, the step of performing I/O virtualization on the physical I/O device that needs to perform I/O with the instance includes:
creating a VF device for the physical I/O device that needs to perform I/O with the instance by adopting an SRIOV technology, where the VF device is configured to perform exchange data with each VCPU in the instance; and
registering the VF device as a virtual I/O device of a specified type by using an operating system of the instance.

In an embodiment, the I/O request occurring between the instance and the virtual I/O device adopts an io-uring protocol.

In an embodiment, the method further includes:
performing acceleration processing on data related to the I/O request occurring between the instance and the virtual I/O device by using an acceleration module, where the acceleration processing includes one or more of encryption and decryption, compression or statistical unloading.

In an embodiment, the acceleration module is bound to a memory address allocated by the host machine for the virtual I/O device, and the virtual I/O device transfers the I/O request occurring between the virtual I/O device and the instance to the device queue; the device queue triggers the acceleration module to access the memory address and perform the acceleration processing on the data related to the I/O request; the device queue transfers the I/O request to the I/O unloading card, to allow the I/O unloading card to sense the I/O request and read the data after the acceleration processing from the memory address.

It is worth noting that technical details in the various embodiments of the I/O unloading method mentioned above, reference may be made to the relevant descriptions of the CPU in the system embodiments mentioned above, to save space, and details are not described herein again, which should not cause a loss of the protection scope of the present application.

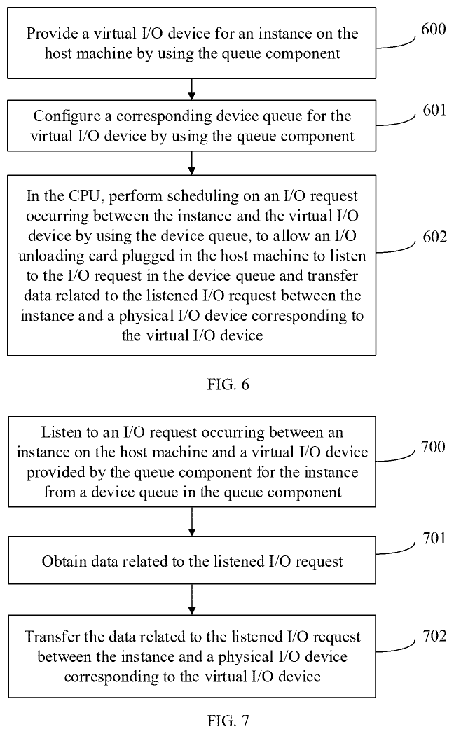

FIG. 7 is a schematic flowchart of another I/O unloading method in a cloud environment provided by another exemplary embodiment of the present application. The method can be implemented by an I/O unloading card plugged into a host machine in the system embodiment mentioned above, and a CPU of the host machine is equipped with a queue component. Referring to FIG. 7, the method can include:
step 700, listen to an I/O request occurring between an instance on the host machine and a virtual I/O device provided by the queue component for the instance from a device queue in the queue component;
step 701, obtain data related to the listened I/O request; and
step S702, transfer the data related to the listened I/O request between the instance and a physical I/O device corresponding to the virtual I/O device.

In an embodiment, an application specific integrated circuit ASIC is adopted to construct the queue component, and the queue component is connected to an internal bus of the CPU.

In an embodiment, the device queue includes a first layer queue and a second layer queue, and the queue component associates a first layer queue of a first specified number and a second layer queue of a second specified number for the virtual I/O device; establishes a mapping relationship between the first layer queue and the second layer queue associated with the virtual I/O device; docks the first layer queue associated with the virtual I/O device to each VCPU in the instance; and docks the second layer queue associated with the virtual I/O device to the physical I/O device corresponding to the virtual I/O device through the I/O unloading card.

In an embodiment, the method further includes:
performing simulation on the physical I/O device to generate a simulation device corresponding to the physical I/O device; and
binding the second layer queue associated with the virtual I/O device to the simulation device, to dock the second layer queue associated with the virtual I/O device to the physical I/O device.

In an embodiment, the method further includes:
obtaining a response message corresponding to a read request; and adding metadata information in the response message to a specified queue in the second layer queue associated with the virtual I/O device, allowing the queue component to schedule the metadata information in the specified queue to a first queue according to load information.

In an embodiment, the step of transferring the data related to the listened I/O request between the instance and the physical I/O device corresponding to the virtual I/O device can include: writing a data portion in the response message into a memory space corresponding to the instance; and adding a memory address where the data portion is located to the metadata information, allowing the queue component to trigger a VCPU docked with a target queue to read the data portion in the response message according to the memory address in the metadata information.

In an embodiment, the queue component adds metadata information of a write request initiated by the instance to the virtual I/O device into the first layer queue associated with the virtual I/O device; and schedules the metadata information of the write request to a second queue in the second layer queue associated with the virtual I/O device; the method further includes:
processing the write request by using a physical I/O device docked with the second queue.

In an embodiment, the step of transferring the data related to the listened I/O request between the instance and the physical I/O device corresponding to the virtual I/O device can include: reading the metadata information from the second queue; obtaining a data portion of the write request according to a memory address in the metadata information; and sending the data portion to the physical I/O device docked with the second queue;
where the queue component writes the data portion corresponding to the write request into a memory space corresponding to the instance; and adds the memory address where the data portion is located to the metadata information.

In an embodiment, the I/O request occurring between the instance and the virtual I/O device adopts an io-uring protocol.

It is worth noting that technical details in the various embodiments of the I/O unloading method mentioned above, reference may be made to the relevant descriptions of the I/O unloading card in the system embodiments mentioned above, to save space, and details are not described herein again, which should not cause a loss of the protection scope of the present application.

In addition, some processes described in the above embodiments and the accompanying drawings contain a plurality of operations that appear in a specific order, but it should be clearly understood that these operations may be executed out of the order in which they appear in this document or in parallel. The serial numbers of the operations, such as 700 and 701, are only used to distinguish different operations, and the serial numbers themselves do not represent any execution order. In addition, these processes may include more or fewer operations, and these operations may be performed in sequence or in parallel. It should be noted that the descriptions of “first” and “second” herein are used to distinguish different queue layers, queues, etc., and do not represent the sequence, nor do they limit that “first” and “second” are different types.

FIG. 8 is a schematic structural diagram of a CPU provided by yet another exemplary embodiment of the present application, which is installed in a host machine and equipped with a queue component 80. As shown in FIG. 8, the CPU can be configured to execute one or more computer instructions to:
provide a virtual I/O device for an instance on the host machine by using the queue component 80;
configure a corresponding device queue for the virtual I/O device by using the queue component 80; and
in the CPU, perform scheduling on an I/O request occurring between the instance and the virtual I/O device by using the device queue, to allow an I/O unloading card plugged in the host machine to listen to the I/O request in the device queue and transfer data related to the listened I/O request between the instance and a physical I/O device corresponding to the virtual I/O device.

In an embodiment, an application specific integrated circuit ASIC is adopted to construct the queue component 80, the queue component 80 is connected to an internal bus of the CPU.

In an embodiment, the device queue is respectively docked with the virtual I/O device and the I/O unloading card, and the virtual I/O device transfers the I/O request occurring between the virtual I/O device and the instance to the device queue, and the device queue transfers the I/O request to the I/O unloading card, allowing the I/O unloading card to sense the I/O request.

In an embodiment, the device queue includes a first layer queue and a second layer queue, and the queue component 80 is further configured to:
associate a first layer queue of a first specified number and a second layer queue of a second specified number for the virtual I/O device;
establish a mapping relationship between the first layer queue and the second layer queue associated with the virtual I/O device;
dock the first layer queue associated with the virtual I/O device to each VCPU in the instance; and
dock the second layer queue associated with the virtual I/O device to the physical I/O device corresponding to the virtual I/O device through the I/O unloading card.

In an embodiment, in the process of performing scheduling on the I/O request occurring between the instance and the virtual I/O device, the queue component 80 can be configured to:
read load information of each VCPU in the instance in a process of the instance initiating a read request to the virtual I/O device; and
schedule the read request to a first queue in the first layer queue associated with the virtual I/O device according to the load information, to process the read request by using a VCPU docked with the first queue.

In an embodiment, in the process of scheduling the read request to the first queue in the first layer queue associated with the virtual I/O device according to the load information, the queue component 80 can be configured to:
schedule metadata information in a specified queue to the first queue according to the load information, where the I/O unloading card obtains a response message corresponding to the read request, and adds the metadata information in the response message to the specified queue in the second layer queue associated with the virtual I/O device.

In an embodiment, the queue component 80 can be further configured to:
trigger a VCPU docked with a target queue to read a data portion in the response message according to a memory address in the metadata information, where the I/O unloading card writes the data portion in the response message into a memory space corresponding to the instance; and adds the memory address where the data portion is located to the metadata information.

In an embodiment, in the process of performing scheduling on the I/O request occurring between the instance and the virtual I/O device by using the device queue, the queue component 80 can be configured to:
add metadata information of a write request initiated by the instance to the virtual I/O device into the first layer queue associated with the virtual I/O device; and
schedule the metadata information of the write request to a second queue in the second layer queue associated with the virtual I/O device;
where the I/O unloading card processes the write request by using a physical I/O device docked with the second queue.

In an embodiment, the queue component 80 can be configured to:
write a data portion corresponding to the write request into a memory space corresponding to the instance; and add a memory address where the data portion is located to the metadata information;
where the I/O unloading card reads the metadata information from the second queue; obtains the data portion of the write request according to the memory address in the metadata information; and sends the data portion to the physical I/O device docked with the second queue.

In an embodiment, in the process of providing the virtual I/O device for the instance on the host machine, the queue component 80 can be configured to:
perform I/O virtualization on a physical I/O device that needs to perform I/O with the instance to generate a virtual I/O device corresponding to the physical I/O device.

In an embodiment, in the process of performing I/O virtualization on the physical I/O device that needs to perform I/O with the instance, the queue component 80 can be configured to:
create a VF device for the physical I/O device that needs to perform I/O with the instance by adopting an SRIOV technology, where the VF device is configured to perform exchange data with each VCPU in the instance; and
register the VF device as a virtual I/O device of a specified type by using an operating system of the instance.

In an embodiment, the I/O request occurring between the instance and the virtual I/O device adopts an io-uring protocol.

In an embodiment, the queue component 80 can further include an acceleration module, and the queue component 80 can be further configured to:
perform acceleration processing on data related to the I/O request occurring between the instance and the virtual I/O device by using an acceleration module, where the acceleration processing includes one or more of encryption and decryption, compression or statistical unloading.

In an embodiment, the acceleration module is bound to a memory address allocated by the host machine for the virtual I/O device, and the virtual I/O device transfers the I/O request occurring between the virtual I/O device and the instance to the device queue; the device queue triggers the acceleration module to access the memory address and perform the acceleration processing on the data related to the I/O request; the device queue transfers the I/O request to the I/O unloading card, to allow the I/O unloading card to sense the I/O request and read the data after the acceleration processing from the memory address.

It is worth noting that technical details in the various embodiments of the CPU mentioned above, reference may be made to the relevant descriptions of the CPU in the system embodiments mentioned above, to save space, and details are not described herein again, which should not cause a loss of the protection scope of the present application.

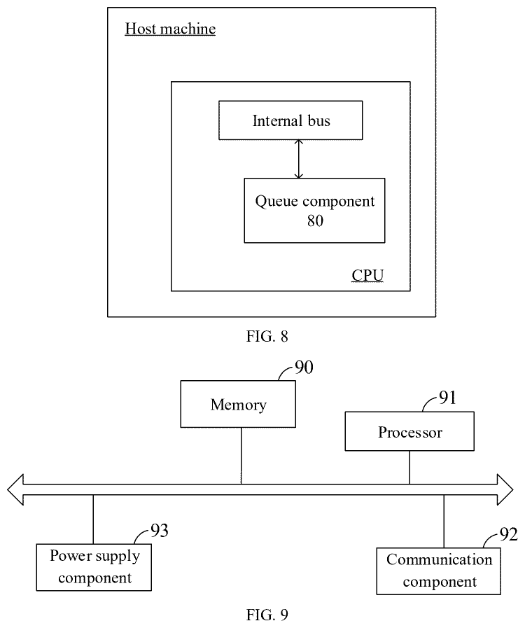

FIG. 9 is a schematic structural diagram of an I/O unloading card provided by yet another exemplary embodiment of the present application, which is plugged into a host machine, and a CPU of the host machine is equipped with a queue component. Referring to FIG. 9, the I/O unloading card can include a memory 90 and a processor 91, the memory 90 is configured to store one or more computer instructions; and the processor 91 is coupled to the memory 90 and configured to the one or more computer instructions to:
listen to an I/O request occurring between an instance on the host machine and a virtual I/O device provided by the queue component for the instance from a device queue in the queue component;
obtain data related to the listened I/O request; and
transfer the data related to the listened I/O request between the instance and a physical I/O device corresponding to the virtual I/O device.

In an embodiment, an application specific integrated circuit ASIC is adopted to construct the queue component, and the queue component is connected to an internal bus of the CPU.

In an embodiment, the device queue includes a first layer queue and a second layer queue, and the queue component associates a first layer queue of a first specified number and a second layer queue of a second specified number for the virtual I/O device; establishes a mapping relationship between the first layer queue and the second layer queue associated with the virtual I/O device; docks the first layer queue associated with the virtual I/O device to each VCPU in the instance; and docks the second layer queue associated with the virtual I/O device to the physical I/O device corresponding to the virtual I/O device through the I/O unloading card.

In an embodiment, the processor 91 can be further configured to:
perform simulation on the physical I/O device to generate a simulation device corresponding to the physical I/O device; and
bind the second layer queue associated with the virtual I/O device to the simulation device, to dock the second layer queue associated with the virtual I/O device to the physical I/O device.

In an embodiment, the processor 91 can be further configured to:
obtain a response message corresponding to a read request; and add metadata information in the response message to a specified queue in the second layer queue associated with the virtual I/O device, allowing the queue component to schedule the metadata information in the specified queue to a first queue according to load information.

In an embodiment, in the process of transferring the data related to the listened I/O request between the instance and the physical I/O device corresponding to the virtual I/O device, the processor 91 is configured to: write a data portion in the response message into a memory space corresponding to the instance; and add a memory address where the data portion is located to the metadata information, allowing the queue component to trigger a VCPU docked with a target queue to read the data portion in the response message according to the memory address in the metadata information.

In an embodiment, the queue component adds metadata information of a write request initiated by the instance to the virtual I/O device into the first layer queue associated with the virtual I/O device; and schedules the metadata information of the write request to a second queue in the second layer queue associated with the virtual I/O device; the processor 91 can be further configured to:
process the write request by using a physical I/O device docked with the

In an embodiment, in the process of transferring the data related to the listened I/O request between the instance and the physical I/O device corresponding to the virtual I/O device, the process 91 can be configured to: read the metadata information from the second queue; obtain a data portion of the write request according to a memory address in the metadata information; and send the data portion to the physical I/O device docked with the second queue;
where the queue component writes the data portion corresponding to the write request into a memory space corresponding to the instance; and adds the memory address where the data portion is located to the metadata information.

In an embodiment, the I/O request occurring between the instance and the virtual I/O device adopts an io-uring protocol.

Furthermore, as shown in FIG. 9, the I/O unloading card further includes: a communication component 92, a power supply component 93 and other components. Only some components are shown schematically in FIG. 9, which does not mean that the I/O unloading card only includes the components shown in FIG. 9.

It is worth noting that technical details in the various embodiments of the I/O unloading card mentioned above, reference may be made to the relevant descriptions of the I/O unloading card in the system embodiments mentioned above, to save space, and details are not described herein again, which should not cause a loss of the protection scope of the present application.

Correspondingly, an embodiment of the present application further provides a computer-readable storage medium storing a computer program, the computer program, when executed by one or more processors, is capable of implementing the steps that can be executed by the CPU or the I/O unloading card in the above method embodiments.

The above-mentioned memory in FIG. 9 is configured to store a computer program and can be configured to store various other data to support operations on the computing platform. Examples of such data include instructions for any application or method operating on the computing platform, contact data, phone book data, messages, pictures, videos, etc. The memory can be implemented by any type of volatile or non-volatile storage device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk or an optical disk.

The above-mentioned communication component in FIG. 9 is configured to facilitate wired or wireless communication between the device where the communication component is located and other devices. The device where the communication component is located can access the wireless network based on communication standards, wireless fidelity (WiFi), mobile communication networks such as second generation (2G) or third generation (3G), fourth generation (4G)/long term evolution (LTE), fifth generation (5G) or their combinations. In an exemplary embodiment, the communication component receives a broadcast signal or broadcast related information from an external broadcast management system via a broadcast channel. In an exemplary embodiment, the communication component further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

The above-mentioned power supply component in FIG. 9 provides power for various components of the device where the power supply component is located. The power supply component can include a power management system, one or more power supplies, and other components associated with generating, managing and distributing power for the device where the power supply component is located.

It should be understood by those skilled in the art that the embodiments of the present application can be provided as a method, a system, or a computer program product. Therefore, the present application can take a form of an entirely hardware embodiment, an entirely software embodiment, or an embodiment combining software and hardware aspects. Moreover, the present application can take a form of a computer program product implemented on one or more computer-usable storage medium (including but not limited to disk storage, compact disc read-only memory (CD-ROM), optical storage, etc.) containing computer-usable program codes.

The present application is described with reference to a flowchart and/or a block diagram of the method, the device (system), and the computer program product according to the embodiments of the present application. It should be understood that each flow and/or block in the flowchart and/or block diagram, and a combination of the flow and/or block in the flowchart and/or block diagram can be implemented by computer program instructions. These computer program instructions can be provided to a processor of a general-purpose computer, special-purpose computer, embedded processor or other programmable data processing device to produce a machine, such that the instructions which are executed by the processor of the computer or other programmable data processing device produce a mean for implementing a function specified in one or more flow in the flowchart and/or one or more blocks in the block diagram.

These computer program instructions can also be stored in a computer-readable memory that can direct a computer or other programmable data processing device to work in a particular manner, such that the instructions stored in the computer-readable memory produce an article of manufacture including instruction means that implement a function specified in one or more flow in the flowchart and/or one or more blocks in the block diagram.

These computer program instructions can also be loaded onto a computer or other programmable data processing device, such that a series of operational steps are performed on the computer or other programmable device to produce a computer-implemented process, such that the instructions executed on the computer or other programmable device provide steps for implementing a function specified in one or more flow in the flowchart and/or one or more blocks in the block diagram.

In a typical configuration, the computing device includes one or more processors (CPU), an input/output interface, a network interface, and a memory.

The memory may include a non-permanent memory, a random access memory (RAM) and/or a nonvolatile memory in the computer-readable medium, such as read-only memory (ROM) or flash memory (flash RAM). The memory is an example of the computer-readable medium.

The computer-readable medium, including permanent and non-permanent, removable and non-removable media, can realize information storage by any method or technology. Information can be computer-readable instructions, data structures, modules of programs or other data. An example of the storage medium for the computer includes, but is not limited to: a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, a compact disc read-only memory (CD-ROM), and a digital versatile disc (DVD), or other optical storage, a magnetic cassettes, a magnetic tape disk storage or other magnetic storage devices or any other non-transmission medium, can be used to store information that can be accessed by the computing device. According to the definition herein, the computer-readable medium does not include a temporary computer-readable media (transitory media), such as a modulated data signal and a carrier wave.

It should also be noted that the terms “including”, “containing” or any other variation thereof are intended to cover non-exclusive inclusion, so that a process, method, commodity or device including a series of elements includes not only those elements, but also other elements not explicitly listed, or includes elements inherent to such process, method, commodity or device. Without more restrictions, an element defined by a sentence “including a” does not exclude the existence of other identical elements in the process, method, commodity or equipment including the above elements.

The above are only embodiments of the present application, and are not used to limit the present application. For those skilled in the art, various modifications and variations are possible for the present application. Any modification, equivalent replacement, improvement, etc. made within the spirit and principle of the present application should be included in the protection scope of the present application.

1. An input/output (I/O) unloading system in a cloud environment, comprising: a central processing unit (CPU) of a host machine and an I/O unloading card plugged into the host machine, the CPU is equipped with a queue component,
the queue component is configured to: provide a virtual I/O device and a device queue corresponding to the virtual I/O device for an instance on the host machine; and in the CPU, perform scheduling on an I/O request occurring between the instance and the virtual I/O device by using the device queue;
the I/O unloading card is configured to: listen to the I/O request in the device queue; and transfer data related to the listened I/O request between the instance and a physical I/O device corresponding to the virtual I/O device.

2. The system according to claim 1, wherein an application specific integrated circuit (ASIC) is adopted to construct the queue component, the queue component is connected to an internal bus of the CPU.

3. The system according to claim 1, wherein the device queue is respectively docked with the virtual I/O device and the I/O unloading card, and the virtual I/O device transfers the I/O request occurring between the virtual I/O device and the instance to the device queue, and the device queue transfers the I/O request to the I/O unloading card, allowing the I/O unloading card to sense the I/O request.

4. The system according to claim 1, wherein the device queue comprises a first layer queue and a second layer queue, and the queue component is further configured to:
associate a first layer queue of a first specified number and a second layer queue of a second specified number for the virtual I/O device;
establish a mapping relationship between the first layer queue and the second layer queue associated with the virtual I/O device;
dock the first layer queue associated with the virtual I/O device to each virtual CPU (VCPU) in the instance; and
dock the second layer queue associated with the virtual I/O device to the physical I/O device corresponding to the virtual I/O device through the I/O unloading card.

5. The system according to claim 4, wherein the I/O unloading card is further configured to:
perform simulation on the physical I/O device to generate a simulation device corresponding to the physical I/O device; and
bind the second layer queue associated with the virtual I/O device to the simulation device, to dock the second layer queue associated with the virtual I/O device to the physical I/O device.

6. The system according to claim 4, wherein in the process of performing scheduling on the I/O request occurring between the instance and the virtual I/O device by using the device queue, the queue component is configured to:
read load information of each VCPU in the instance in a process of the instance initiating a read request to the virtual I/O device; and
schedule the read request to a first queue in the first layer queue associated with the virtual I/O device according to the load information, to process the read request by using a VCPU docked with the first queue.

7. The system according to claim 6, wherein the I/O unloading card is further configured to obtain a response message corresponding to the read request; and add metadata information in the response message to a specified queue in the second layer queue associated with the virtual I/O device,
in the process of scheduling the read request to the first queue in the first layer queue associated with the virtual I/O device according to the load information, the queue component is configured to schedule the metadata information in the specified queue to the first queue according to the load information.

8. The system according to claim 7, wherein in the process of transferring the data related to the listened I/O request between the instance and the physical I/O device corresponding to the virtual I/O device, the I/O unloading card is configured to: write a data portion in the response message into a memory space corresponding to the instance; and add a memory address where the data portion is located to the metadata information;
the queue component is further configured to: trigger a VCPU docked with a target queue to read the data portion in the response message according to the memory address in the metadata information.

9. The system according to claim 4, wherein in the process of performing scheduling on the I/O request occurring between the instance and the virtual I/O device by using the device queue, the queue component is configured to: add metadata information of a write request initiated by the instance to the virtual I/O device into the first layer queue associated with the virtual I/O device; and schedule the metadata information of the write request to a second queue in the second layer queue associated with the virtual I/O device;
the I/O unloading card is further configured to process the write request by using a physical I/O device docked with the second queue.

10. The system according to claim 9, wherein the queue component is further configured to: write a data portion corresponding to the write request into a memory space corresponding to the instance; and add a memory address where the data portion is located to the metadata information;
in the process of transferring the data related to the listened I/O request between the instance and the physical I/O device corresponding to the virtual I/O device, the I/O unloading card is configured to: read the metadata information from the second queue; obtain the data portion of the write request according to the memory address in the metadata information; and send the data portion to the physical I/O device docked with the second queue.

11. The system according to claim 1, wherein in the process of providing the virtual I/O device for the instance on the host machine, the queue component is configured to:
perform I/O virtualization on a physical I/O device that needs to perform I/O with the instance to generate a virtual I/O device corresponding to the physical I/O device.

12. The system according to claim 11, wherein in the process of performing I/O virtualization on the physical I/O device that needs to perform I/O with the instance, the queue component is configured to:
create a VF device for the physical I/O device that needs to perform I/O with the instance by adopting single root I/O virtualization (SRIOV) technology, wherein the VF device is configured to perform exchange data with each VCPU in the instance; and
register the VF device as a virtual I/O device of a specified type by using an operating system of the instance.

13. The system according to claim 1, wherein the I/O request occurring between the instance and the virtual I/O device adopts an io-uring protocol.

14. The system according to claim 1, wherein the queue component further comprises an acceleration module, and the acceleration module is configured to:
perform acceleration processing on data related to the I/O request occurring between the instance and the virtual I/O device, wherein the acceleration processing comprises one or more of encryption and decryption, compression or statistical unloading.

15. The system according to claim 14, wherein the acceleration module is bound to a memory address allocated by the host machine for the virtual I/O device, and the virtual I/O device transfers the I/O request occurring between the virtual I/O device and the instance to the device queue; the device queue triggers the acceleration module to access the memory address and perform the acceleration processing on the data related to the I/O request; the device queue transfers the I/O request to the I/O unloading card, so that the I/O unloading card can sense the I/O request and read the data after the acceleration processing from the memory address.

16. An input/output (I/O) unloading method in a cloud environment, applicable for a central processing unit (CPU) in a host machine, wherein the CPU is equipped with a queue component, and the method comprises:
providing a virtual I/O device for an instance on the host machine by using the queue component;
configuring a corresponding device queue for the virtual I/O device by using the queue component; and
in the CPU, performing scheduling on an I/O request occurring between the instance and the virtual I/O device by using the device queue, to allow an I/O unloading card plugged in the host machine to listen to the I/O request in the device queue and transfer data related to the listened I/O request between the instance and a physical I/O device corresponding to the virtual I/O device.

17. An input/output (I/O) unloading method in a cloud environment, applicable for an I/O unloading card plugged into a host machine, wherein a central processing unit (CPU) of the host machine is equipped with a queue component, and the method comprises:
listening to an I/O request occurring between an instance on the host machine and a virtual I/O device provided by the queue component for the instance from a device queue in the queue component;
obtaining data related to the listened I/O request; and
transferring the data related to the listened I/O request between the instance and a physical I/O device corresponding to the virtual I/O device.

18. A central processing unit (CPU), installed in a host machine, wherein the CPU is equipped with a queue component, and the CPU is configured to execute one or more computer instructions to perform the input/output (I/O) unloading method in the cloud environment according to claim 16.

19. An input/output (I/O) unloading card, plugged into a host machine, wherein a central processing unit (CPU) of the host machine is equipped with a queue component, and the I/O unloading card comprises a memory and a processor,
the memory is configured to store one or more computer instructions;
the processor is coupled to the memory and configured to execute the one or more computer instructions to perform the I/O unloading method in the cloud environment according to claim 17.

20. A non-transitory computer-readable storage medium storing computer instructions, wherein the computer instructions, when executed by one or more processors, cause the one or more processors to perform the input/output (I/O) unloading method in the cloud environment according to claim 16.
